(19) United States
(12) Patent Application Publication
(10) Pub. No.: US 2024/0114965 A1
(43) Pub. Date: Apr. 11, 2024

(54) Aerosol Generation Device Heating Component

(71) Applicant: JT International SA, Geneva (CH)

(72) Inventor: Herman Hijma, Kampen (NL)

(73) Assignee: JT International SA, Geneva (CH)

(21) Appl. No.: 18/275,338

(22) PCT Filed: Jan. 26, 2022
(86) PCT No.: PCT/EP2022/051782

§ 371 Date: Aug. 1, 2023

(30) Foreign Application Priority Data
Feb. 2, 2021 (EP) 21154733.6

(51) Int. Cl. A24F 40/465; A24F 40/20; H05B 6/10

(52) U.S. Cl. CPC A24F 40/465; A24F 40/20; H05B 6/108

(57) ABSTRACT

An aerosol generation device heating component includes an electromagnetic field generator configured to at least partially surround a heating chambers, the heating chamber configured to house one or more susceptors. The electromagnetic field generator includes a plurality of co-wound helical strands. Each helical strand of the plurality of helical strands is coiled to comprise a plurality of windings. The windings of a first helical strand of the plurality of helical strands are of a first size, and the windings of a second helical strand (74) of the plurality of helical strands are of a second size, wherein the first size and the second size are different sizes.

### FIELD OF INVENTION

The present invention relates to aerosol generation devices, and more specifically induction heating for aerosol generation devices.

### BACKGROUND

Aerosol generation devices such as electronic cigarettes and other aerosol inhalers or vaporisation devices are becoming increasingly popular consumer products.

Heating devices for vaporisation or aerosolisation are known in the art. Such devices typically include a heating chamber and heater. In operation, an operator inserts the product to be aerosolised or vaporised into the heating chamber. The product is then heated with an electronic heater to vaporise the constituents of the product for the operator to inhale. In some examples, the product is a tobacco product similar to a traditional cigarette. Such devices are sometimes referred to as “heat not burn” devices in that the product is heated to the point of aerosolisation, without being combusted.

Problems faced by known aerosol generation devices include the control of heating, and the effective use of energy.

### SUMMARY OF INVENTION

According to a first aspect, there is provided an aerosol generation device heating component, the heating component comprising an electromagnetic field generator configured to at least partially surround a heating chamber, the heating chamber configured to house one or more susceptors heatable by the electromagnetic field generator, and the electromagnetic field generator comprising a plurality of co-wound helical strands, wherein each helical strand of the plurality of helical strands is coiled to comprise a plurality of windings, and the windings of a first helical strand of the plurality of helical strands are of a first size, and the windings of a second helical strand of the plurality of helical strands are of a second size, wherein the first size and the second size are different sizes.

In this way, the smaller windings of the first helical strand are closer to the axial centre of the induction coil than the larger windings of the second helical strand. As such, when the induction coil surrounds the heating chamber, with the susceptors in the heating chamber, the windings of the first helical strand are closer to the susceptors than the windings of the second helical strand. By virtue of being closer to the susceptors, the first helical strand is able to heat the susceptors to a greater extent than the second helical strand for a given amount of power applied to the helical strands.

Preferably, the helical strands are interleaved such that the windings of the first helical strand alternate with the windings of the second helical strand at least partially along an axial length of the electromagnetic field generator.

In this way, an even distribution of the different sized windings is provided along the length of the induction coil, and therefore allows for the first helical strand and the second helical strand to each provide inductive heating to the same areas of the susceptors, providing an even overall heating.

Preferably, the plurality of helical strands further comprises a third helical strand and the helical strands are interleaved such that the windings of the first, second and third helical strand alternate with one another at least partially along the axial length of the electromagnetic field generator, and wherein the windings of the third helical strand are the same size as the windings of one of the first helical stand and the second helical strand, or a different size to the windings.

Preferably, the plurality of helical strands are interleaved such that the windings of each helical strand alternate with one another at least partially along an axial length of the electromagnetic field generator.

Preferably, the windings of the first helical strand have a diameter less than the windings of the second helical strand.

Preferably, the plurality of windings of each helical strand are substantially circular.

Preferably, the plurality of windings of each helical strand are substantially triangular

In this way, the one or more susceptors can be arranged substantially in the corners of the triangular windings and a higher magnetic flux can be imparted to the susceptors.

Preferably, the electromagnetic field generator is an induction coil configured to heat the one or more susceptors arranged within the heating chamber.

Preferably, the aerosol generation device heating component further comprises a temperature isolating layer internal to the induction coil and configured to be between the induction coil and the one or more susceptors, wherein the temperature isolating layer is permeable to a magnetic field generated by the induction coil and is arranged to inhibit heat flow from the one or more susceptors to the induction coil.

The temperature isolating layer inhibits heat flow from the one or more susceptors to the induction coil. The closer the susceptor(s) are positioned to the induction coil, the greater they are heated as the amount of energy transfer from the induction coil to the susceptor(s) is improved. However, the susceptor(s) will also heat the induction coil if placed too close together; increasing the induction coil temperature can decrease its efficiency. This presents a coil/susceptor paradox in that it is more efficient to heat the susceptor(s) when they are closer to the coil, but the coil is less efficient when the susceptors are too close. The temperature isolating layer addresses this issue by allowing the magnetic field generated by the induction coil to pass from the coil to the susceptor(s) to heat the susceptors by induction, whilst inhibiting the transfer of heat from the susceptor(s) back to the coil. This improves the efficiency of the induction coil, thereby improving the efficiency of the aerosol generation device. The temperature isolating layer also inhibits heat transfer through the aerosol generation device by confining the generated heat to the heating chamber; this improves the efficiency of the heating of the aerosol generating article and inhibits the device undesirably heating in the user's hand.

Preferably, the temperature isolating layer is at least one of a thermal diode or heat reflector.

Preferably, the windings the first helical strand are configured to be closer to the one or more susceptors than the windings of the second helical strand.

Preferably, each helical strand is separately connectable to a controller configured to selectively power each of the helical strands.

In this way, when the induction coil is activated, one or both of the first helical strand and the second helical strand can be powered. When the windings of the first helical strand are smaller than the windings of the second helical stand, they are closer to the susceptors, and the first helical strand heats the susceptors to a greater extent than the second helical strand for a given amount of power applied to the helical strands. As such, the selective activation of the helical strands allows for variable heating to be applied. That is, powering only the first helical strand heats the susceptors, by induction, to a first temperature. Powering only the second helical strand heats the susceptors, by induction, to a second temperature that is less than the first temperature. Simultaneously powering both the first and second helical strands can also heat the susceptors to a third temperature that is greater than the first temperature. In this way, variable heating can be applied by powering the strands of the induction coil with a fixed power level.

Preferably, each helical strand is formed from one or more wires configured to generate an electromagnetic field when an AC current is passed through the one or more wires

Preferably, each helical strand is formed from a plurality of adjacent wires.

Increasing the number of adjacent wires in each helical strand increases the surface area of the strand, thereby increasing the magnetic field generated around the helical strand. In this way, forming each helical strand from a plurality of adjacent wires can maximise the magnetism for induction, thereby improving the heating of the susceptors.

According to a second aspect, there is provided an aerosol generation device comprising the heating component of the first aspect and a heating chamber configured to receive an aerosol generating article.

Preferably, the aerosol generation device further comprises one or more susceptors arranged in the heating chamber.

Preferably, the electromagnetic field generator is configured to inductively heat the one or more susceptors to heat without burning an aerosol generating article received in the heating chamber

According to a third aspect, there is provided an aerosol generation device heating component, the heating component comprising an electromagnetic field generator configured to at least partially surround a heating chamber, the heating chamber configured to house one or more susceptors heatable by the electromagnetic field generator, and the electromagnetic field generator comprising a plurality of co-wound helical strands, wherein each helical strand of the plurality of helical strands is coiled to comprise a plurality of windings.

Preferably, the plurality of helical strands are interleaved such that the windings of each helical strand alternate with one another at least partially along an axial length of the electromagnetic field generator.

Preferably, the windings of a first helical strand the plurality of helical strands are of a first size, and the windings of a second helical strand of the plurality of helical strands are of a second size, wherein the first size and the second size are different sizes.

Preferably, the aerosol generation device heating component of the third aspect comprises one or more of the preferable features of the aerosol generation device heating component of the first aspect.

According to a fourth aspect, there is provided an aerosol generation device comprising the heating component of the third aspect and a heating chamber configured to receive an aerosol generating article.

Preferably, the aerosol generation device further comprises one or more susceptors arranged in the heating chamber.

Preferably, the electromagnetic field generator is configured to inductively heat the one or more susceptors to heat without burning an aerosol generating article received in the heating chamber.

### BRIEF DESCRIPTION OF THE DRAWINGS

Embodiments of the invention are now described, by way of example, with reference to the drawings, in which:

FIG. 1 is a cross-sectional view of an aerosol generating system comprising an aerosol generating device and an aerosol generating article ready to be positioned in a heating chamber of the aerosol generating device;

FIG. 2 is a diagrammatic cross-sectional view of the aerosol generating system of FIG. 1, showing the aerosol generating article positioned in the heating chamber of the aerosol generating device;

FIG. 3 is a detailed diagrammatic perspective view of the heating chamber of the aerosol generating device of FIGS. 1 and 2, showing one of a plurality of inductively heatable susceptors mounted on an inner surface of the heating chamber and a coil support structure;

FIG. 4 is a diagrammatic cross-sectional view from an end of the heating chamber shown in FIG. 3, showing a plurality of inductively heatable susceptors spaced around a periphery of the heating chamber;

FIG. 5 is a diagrammatic view showing the detail of the inductively heatable susceptors of FIGS. 3 and 4;

FIG. 6 is a diagrammatic view similar to FIG. 5, showing inductively heatable susceptors with an alternative geometry;

FIG. 7 is a perspective view of an induction coil;

FIG. 8 is a perspective view of an induction coil;

FIG. 9A is a cross-sectional view of an induction coil;

FIG. 9B is a perspective view of an induction coil;

FIG. 10A shows a view in the direction into a heating chamber, from the open first end toward the base;

FIG. 10B shows a view in the direction into a heating chamber that is a variation of the heating chamber of FIG. 10A, from the open first end toward the base; and

FIG. 11 is a perspective view of the heating chamber and induction coil support of FIG. 10A.

### DETAILED DESCRIPTION

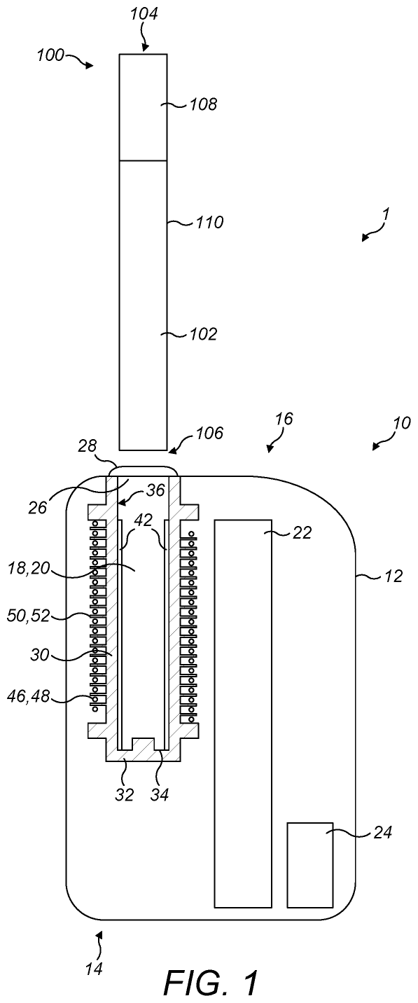

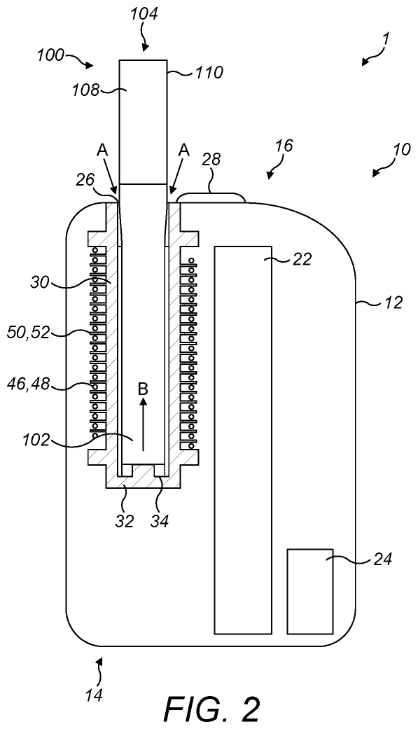

Referring initially to FIGS. 1 and 2, there is shown diagrammatically an example of an aerosol generating system 1. The aerosol generating system 1 comprises an aerosol generating device 10 (also referred to as an aerosol generation device 10) and an aerosol generating article 100 for use with the device 10.

The aerosol generating article 100 comprises an aerosol generating substrate 102 (such as tobacco). The aerosol generating device 10 is configured to heat, without burning, the aerosol generating article 100, to form an aerosol from the aerosol generating substrate 102 for inhalation by a user of the device.

The aerosol generating device 10 can be configured to generate an aerosol or vapour by heating the aerosol generating substrate 102 to a temperature typically in the range 150° C. to 300° C. Heating the aerosol generating substrate 102 to a temperature within this range, without burning or combusting the aerosol generating substrate 102, generates a vapour which typically cools and condenses to form an aerosol for inhalation by a user of the device 10. For the purposes of the present disclosure, the terms ‘aerosol’ and ‘vapour’ may be used interchangeably, particularly with regard to the form of the inhalable medium that is generated for inhalation by a user.

The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially cylindrical cross-section for receiving the aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise heat transfer to the main body 12.

The aerosol generating device 10 can optionally include a sliding cover 28 movable transversely between a closed position (see FIG. 1) in which it covers the open first end 26 of the heating chamber 18 to prevent access to the heating chamber 18 and an open position (see FIG. 2) in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. Typically, the aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. Such a consumable can be referred to as a tobacco rod. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100 in a manner similar to a traditional cigarette.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a centre hole segment and a filter segment. The cooling segment typically comprises a hollow paper tube having a thickness which is greater than the thickness of the wrapper 110. The centre hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the centre hole segment to form an aerosol with suitable characteristics for inhalation by a user through the filter segment.

The heating chamber 18 has a side wall (or chamber wall) 30 extending between a base 32, located at a second end 34 of the heating chamber 18, and the open first end 26. The side wall 30 and the base 32 are connected to each another and can be integrally formed as a single piece. In the illustrated embodiment, the side wall 30 is tubular and, more specifically, cylindrical. In other embodiments, the side wall 30 can have other suitable shapes, such as a tube with an elliptical or polygonal cross section. In yet further embodiments, the side wall 30 can be tapered.

In the illustrated embodiment, the base 32 of the heating chamber 18 is closed, e.g. sealed or air-tight. That is, the heating chamber 18 is cup-shaped. This can ensure that air drawn from the open first end 26 is prevented by the base 32 from flowing out of the second end 34 and is instead guided through the aerosol generating substrate 102. It can also ensure that a user inserts the aerosol generating article 100 into the heating chamber 18 an intended distance and no further.

The side wall 30 of the heating chamber 18 has an inner surface 36 and an outer surface 38. A plurality of susceptor mounts 40 are formed in the inner surface 36 and are circumferentially spaced around the inner surface 36. The aerosol generating device 10 comprises a plurality of inductively heatable susceptor 42 mounted on the susceptor mounts 40 and, thus, the inductively heatable susceptor 42 are circumferentially spaced around a periphery 44 of the heating chamber 18.

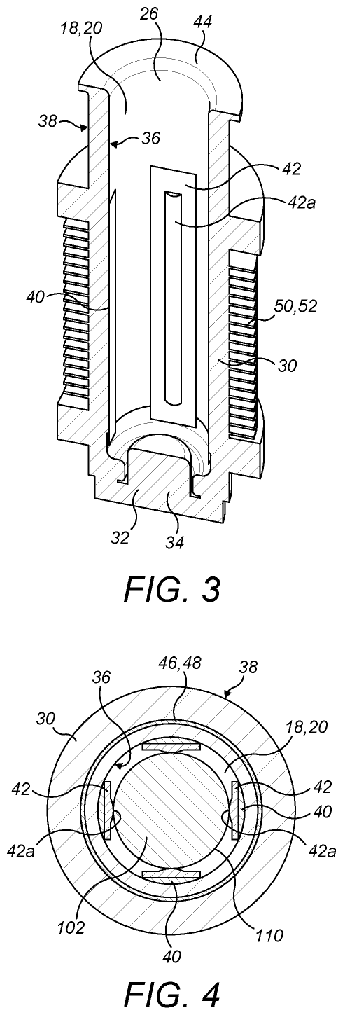

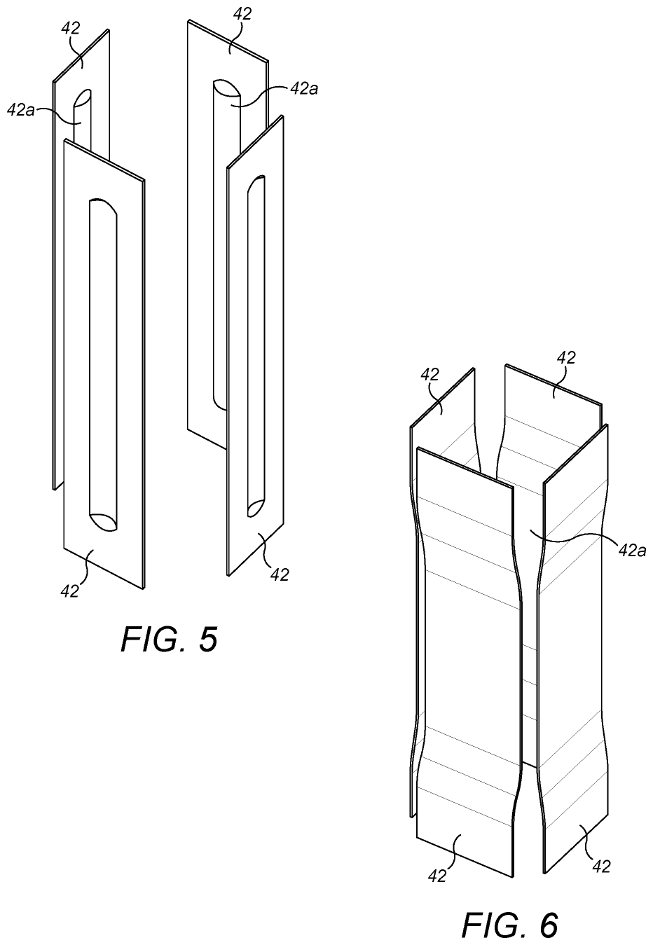

The inductively heatable susceptors 42 are elongate in the longitudinal direction of the heating chamber 18. Each inductively heatable susceptor 42 has a length and a width, and typically the length is at least five times the width. Each inductively heatable susceptor 42 has an inwardly extending portion 42a that extends into the heating chamber 18, in a radial direction from the side wall 30. The inwardly extending portion 42a can comprise an elongate ridge as shown in FIGS. 3 to 5 or can comprise an inwardly deflected portion as shown in FIG. 6. In both cases, the inwardly extending portions 42a are formed easily during fabrication of the inductively heatable susceptors 42. It will be understood by one of ordinary skill in the art that the inwardly extending portions 42a are not limited to the geometries shown in FIGS. 3 to 5 and 6 and that other geometries are entirely within the scope of the present disclosure.

The inwardly extending portions 42a extend towards and contact the aerosol generating substrate 102 as shown in FIG. 4. The inwardly extending portions 42a extend radially inwardly into the heating chamber 18 by a sufficient extent to reduce the effective cross-sectional area of the heating chamber 18. The inwardly extending portions 42a thus form a friction fit with the aerosol generating substrate 102, and more particularly with the wrapper 110 of the aerosol generating article 100, and may cause compression of the aerosol generating substrate 102. The compression of the aerosol generating substrate 102 improves thermal conduction through the aerosol generating substrate 102, for example by eliminating air gaps, and each inwardly extending portion 42a may extend inwardly across the heating chamber 18 by a distance of between 3% and 7%, for example about 5% of the distance across the heating chamber 18.

The aerosol generating device 10 comprises an electromagnetic field generator 46 for generating an electromagnetic field. The electromagnetic field generator 46 comprises a substantially helical induction coil 48. The induction coil 48 has a circular cross-section and extends helically around the substantially cylindrical heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48. The induction coil 48 and the susceptors 42 are heating components that form the overall heating component of the aerosol generating device 10.

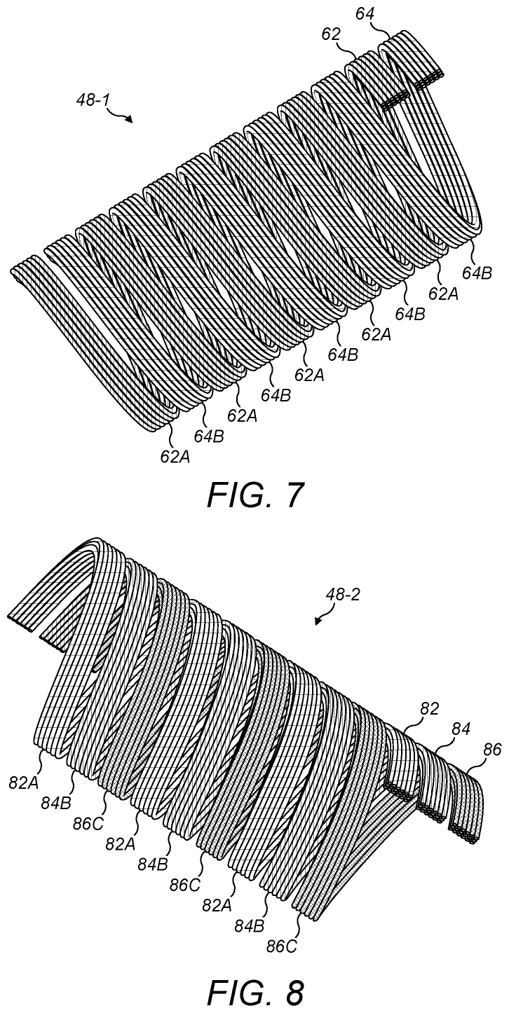

FIGS. 7, 8, 9A and 9B show perspective drawings of exemplary induction coils 48 (48-1, 48-2, 48-3). The induction coils 48 comprise a plurality of helical strands. Each helical strand is coiled to comprise a plurality of loops (also referred to as windings). These loops or windings are the turnings of the coil. The plurality of helical strands are co-wound to form the induction coil 48 such that the loops or windings of each helical strand are interleaved with the loops of the other helical strand(s). That is, the loops or windings of each strand alternate with one another at least partially along an axial length of the induction coil 48.

In the example of FIG. 7, the induction coil 48-1 is formed from two helical strands; a first helical strand 62 and a second helical strand 64. The two helical strands are co-wound such that the loops 62A of the first helical strand 62 alternate with the loops 64B of the second helical strand 64 along the axial length of the induction coil 48-1. That is, the loops alternate in an A-B-A-B-A-B . . . manner, wherein A corresponds to the loops 62A of the first helical strand 62, and B corresponds to the loops 64B of the second helical strand 64.

In the example of FIG. 8, the induction coil 48-2 is formed from three helical strands; a first helical strand 82, a second helical strand 84, and a third helical strand 86. The three helical strands are co-wound such that the loops 82A of the first helical strand 82, the loops 84B of the second helical strand 84 and the loops 86C of the third helical strand 86 alternate with one another along the axial length of the induction coil 48-2. That is, the loops alternate in an A-B-C-A-B-C-A-B-C . . . manner, wherein A corresponds to the loops 82A of the first helical strand 82, B corresponds to the loops 84B of the second helical strand 84, and C corresponds to the loops 86C of the third helical strand 86.

Whilst FIGS. 7 and 8 are described with reference to two helical strands and three helical strands, it will be understood that in other examples the induction coil can comprise a plurality of co-wounds strands, which is any suitable number of helical strands, with alternating windings.

Each of the helical strands can be separately connected to the controller 24 such that they can be selectively powered by the controller 24. In the example of FIG. 7, the first helical strand 62 and second helical strand 64 can be separately powered. In this way, when the induction coil 48 is activated, one or both of the helical strands 62, 64 can be selectively powered. When only one of the helical strands is powered, a first electrical current is induced in the susceptor(s) 42 to heat them to a first temperature, and when both of the helical strands are powered, a second (greater) electrical current can be induced in the susceptor(s) 42 to heat the susceptors 42 to a second (higher) temperature for a given power level applied to each of the helical strands.

That is, in more general terms, by separately powering each of the plurality of helical strands, the temperature applied in the heating chamber 18, by heating the susceptors 42, can be varied by varying the number of helical strands that are powered when the induction coil 48 is activated. This can be beneficial for controlling the temperature of the heating chamber 18 between a first temperature and a second different temperature. In some examples, the second temperature may be a higher temperature, in which a greater number of the helical strands are powered, for a pre-heating phase of an aerosolisation session, and the first temperature may be a lower temperature in which fewer helical strands are powered than for the second temperature, for an aerosolisation phase, after the pre-heating phase in the aerosolisation session, at which the aerosol generating article is heated at a substantially stable temperature to generate the aerosol.

In the examples of FIG. 7 and FIG. 8, the windings of each of the first helical strand 62, 82, the second helical strand 64, 84 (and the third helical strand 86 in the example of FIG. 8) are substantially of the same size. The size can correspond to at least one of the area of the loop, the circumference of the loop, the diameter of the loop or the radius of the loop in a cross-section perpendicular to the direction along the axial length of the induction coil 48.

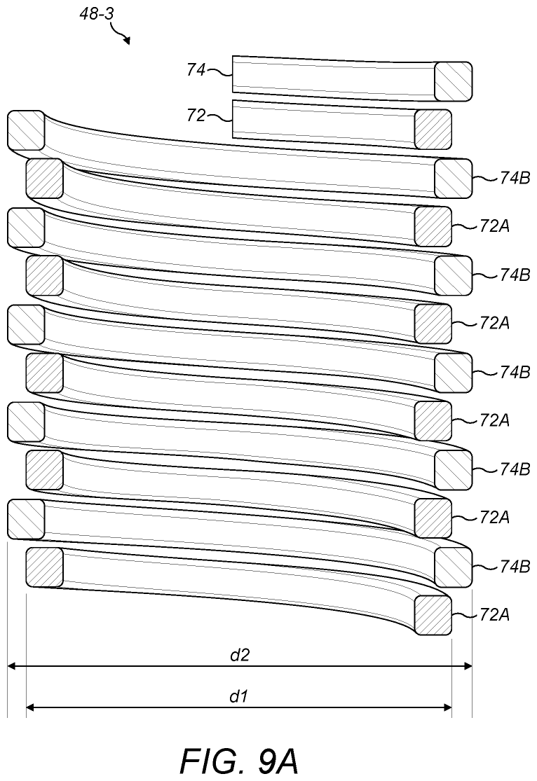

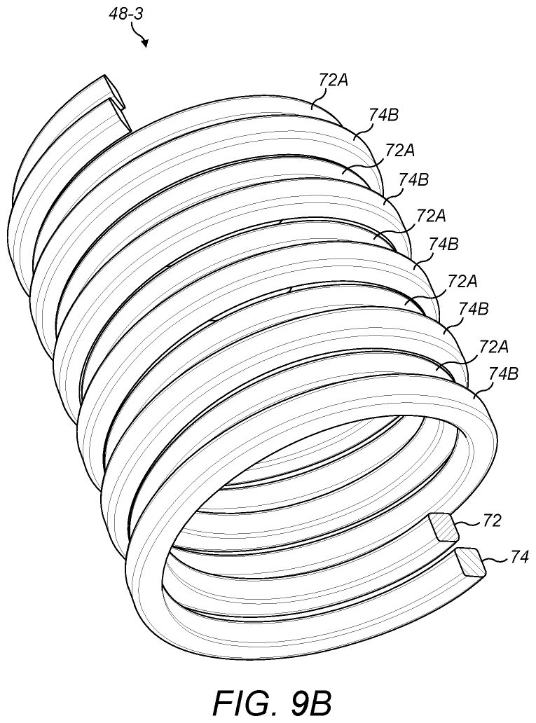

FIGS. 9A and 9B present a variation on the example of FIG. 7. In the example of FIGS. 9A and 9B, the induction coil 48-3 is formed from two helical strands 72, 74 that are co-wound as in FIG. 7.

FIG. 9A shows a cross-sectional diagram of the induction coil 48-3 along the axial direction of the coil 48-3. FIG. 9B shows a perspective diagram of the induction coil 48-3. In the example of FIGS. 9A and 9B, the windings, or loops, 72A in the first helical strand 72 have a first diameter d1 (or first size); the windings, or loops, 74B in the second helical strand 74 have a second diameter d2 (or second size). The first diameter (or first size) and the second diameter (or second size) are different. For example, the second diameter d2 can be greater than the first diameter d1. In other examples, the second diameter (or second size) can be less than the first diameter (or first size).

The smaller windings 72A of the first helical strand 72 are closer to the axial centre of the induction coil 48-3 than the larger windings 74B of the second helical strand 74. As such, when the induction coil 48-3 surrounds the heating chamber 18, with the susceptors 42 in the heating chamber 18, the windings 72A of the first helical strand 72 are closer to the susceptors 42 than the windings 74B of the second helical strand 74. By virtue of being closer to the susceptors 42, the first helical strand 72 is able to heat the susceptors 42 to a greater extent than the second helical strand 74 for a given amount of power applied to the helical strands 72, 74.

Due to the co-winding of the first helical strand 72 and the second helical strand 72, the windings alternate between the smaller loops 72A of the first helical strand 72 and the larger loops 74B of the second helical strand 74 at least partially along the length of the induction coil 48-3. This allows for an even distribution of the smaller windings 72A and the larger windings 74B along the length of the induction coil 48-3, and therefore allows for the first helical strand 72 and the second helical strand 78 to each provide inductive heating to the same areas of the susceptors 42, providing an even overall heating.

The first helical strand 72 and the second helical strand 74 can be separately connected to the controller 24, and thus selectively powered by the controller 24. In this way, when the induction coil 48-3 is activated, one or both of the helical strands 72, 74 can be powered. Because the smaller windings 72A of the first helical strand 72 are closer to the susceptors 42, and the first helical strand 72 heats the susceptors 72 to a greater extent than the second helical strand 74 for a given amount of power applied to the helical strands, the selective activation of the helical strands allows for variable heating to be applied. That is, powering only the first helical strand 72 heats the susceptors 42, by induction, to a first temperature. Powering only the second helical strand 74 heats the susceptors 42, by induction, to a second temperature that is less than the first temperature. In this way, variable heating can be applied by powering the strands of the induction coil with a fixed power level. In some examples, the first temperature can be used for a pre-heating phase of an aerosolisation session performed by the aerosol generating device, and the second temperature can be used for an aerosolisation phase of an aerosolisation session performed by the aerosol generating device.

Simultaneously powering both the first 72 and second helical strands 74 can also heat the susceptors 42 to a third temperature that is greater than the first temperature.

In a modification to the induction coil 48-3 of FIGS. 9A and 9B, the induction coil can be formed from a plurality of co-wound helical strands, with each helical strand having windings of a different size to the other helical strands, such that the different sized windings alternate substantially along the axial length of the induction coil. In another modification, a first number of helical strands can have windings of a first size, and a second number of helical strands can have windings of a second size different to the first size.

In the examples of FIGS. 7, 8, 9A and 9B the windings or loops are substantially circular. That is, the loops are substantially circular in a cross-section perpendicular to the axial direction of the induction coil. As such, the shape of the induction coil corresponds to shape of the coil support structure 50 shown in FIGS. 1 to 4 and the coil support grooves 52 therein such that the induction coil fits into the coil support grooves 52 to substantially surround the heating chamber 18.

Returning to FIGS. 1 to 4, it can be seen that the side wall 30 of the heating chamber 18 includes a coil support structure 50 formed in the outer surface 38. In the illustrated example, the coil support structure 50 comprises a coil support groove 52 which extends helically around the outer surface 38. The induction coil 48 is positioned in the coil support groove 52 and is, thus, securely and optimally positioned with respect to the inductively heatable susceptors 42. The coil support groove 52 can surround the heating chamber 18 in a circular manner; that is, the helical windings of the coil support groove 52 are circular in a cross section perpendicular to the axial direction of the heating chamber 18. In this way, an induction coil 48 with substantially circular windings is accommodated by the coil support groove 52.

To accommodate the induction coil 48-3 described with reference to FIGS. 9A and 9B, the coil support grooves 52 in the coil support structure 50 can be dimensioned to accommodate the differently sized windings 72A, 74B of the first 72 and second helical strands 74 in that the grooves in which the smaller windings 72A are housed are deeper than the grooves in which the larger windings 74B are housed.

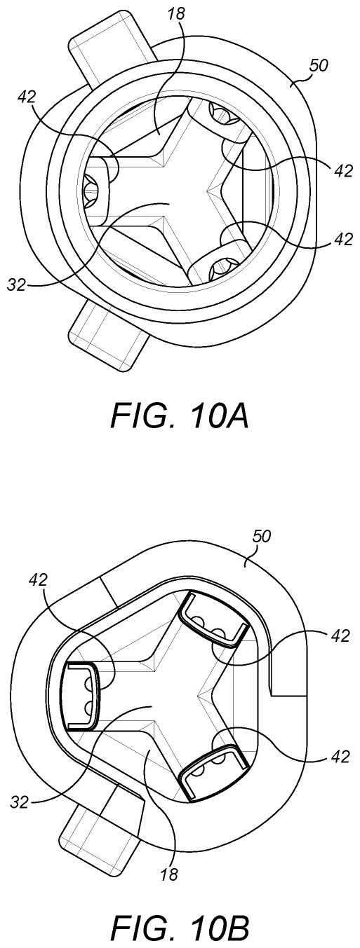

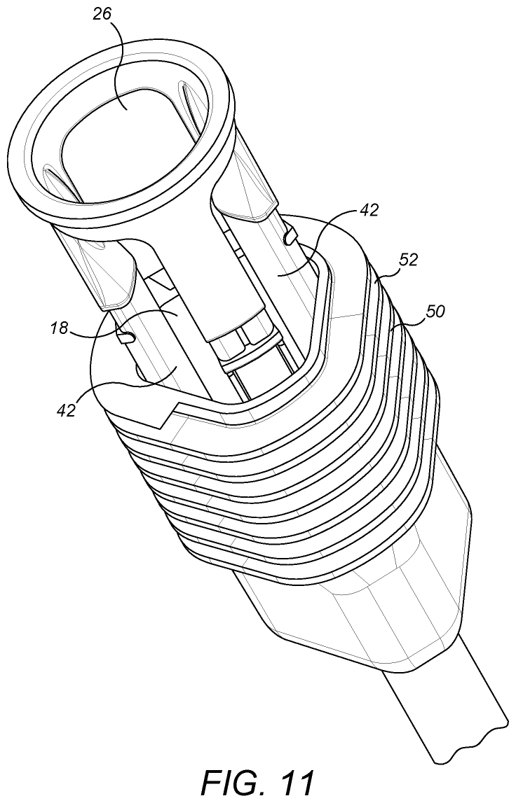

Rather than being substantially circular, the windings or loops described with reference to FIGS. 7, 8, 9A and 9B can be of a different shape. FIGS. 10A and 10B show an example of a heating chamber configured for an induction coil in which the windings are substantially triangular in shape. That is, the helical windings of the strand(s) of the induction coil are triangular in a cross section perpendicular to the axial direction of the induction coil. It will understood that the other features of the induction coils described with reference to FIGS. 7, 8, 9A and 9B (such as the plurality of co-wound strands, with the same or different size loops) can be incorporated into such an example. Advantageously, the triangular windings can allow for the one or more susceptors to be arranged substantially in the corners of the triangular windings and a higher magnetic flux can be imparted to the susceptors.

In FIG. 10A, a view in the direction into a heating chamber 18, from the open first end 26 toward the base 32, is presented, for an example in which the induction coil has helical strands with substantially triangular windings or loops. In the example, the susceptors 42 for use with the induction coil 48 are fitted within the heating chamber 18; in the example the susceptors can be considered as three susceptors plates 42 forming the overall susceptor 42. The susceptor plates 42 are joined to one another by the base 32, which is formed in a three-spoked shape extending from substantially the radial centre of the heating chamber 18 outward to connect to the susceptor plates 42. The heating chamber 18 has a circular opening through which the aerosol generating article is received.

The coil support structure 50 is triangular in shape, with corresponding triangular coil support grooves 52 (as presented in FIG. 11). In this way, the substantially triangular loops or windings of the induction coil can be accommodated in the substantially triangular support grooves. The corners of the triangles of both the support grooves and the coil windings can be pointed, or curved as in FIGS. 10A and 11. The curved corners of the triangles allow for the susceptors to more closely fit to the corners of the triangular windings.

FIG. 11 shows a perspective drawing of the heating chamber 18 and induction coil support 50 of FIG. 10A. For clarity, the induction coil itself is not shown, but it will be understood that the induction coil is accommodated in the coil support grooves 52.

FIG. 10B shows a variation of the heating chamber 18 of FIG. 10A. The heating chamber of FIG. 10B corresponds to that of FIG. 10A, only with a triangular opening rather than a circular opening. In this way, the shape of the opening corresponds to the triangular shape of the loops in the helical inductor coil.

In the examples of FIGS. 10A, 10B and 11, the heating chamber 18 can be configured such that the three susceptor plates 42 are positioned substantially in the corners of the triangular windings.

The induction coil 48 with triangular windings can include all of the features described with reference to FIGS. 7, 8 and 9, only with triangular windings in place of circular windings. In examples in which the triangular coil comprises multiple strands, the triangular windings of each strand can either be the same size or a different size to the triangular windings of the other strands. For example, the induction coil can comprise a first helical strand co-wound with a second helical strand, each having triangular windings. The triangular windings of the first helical strand can be of a first size, and the triangular windings of the second strand can be of a second size different to the first size. In this way, the induction coil can comprise alternatingly sized triangular windings along its axial length in a manner similar to that described with reference to FIGS. 9A and 9B. The size of the triangle can be defined by its perimeter, its area, or its height (the length of perpendicular line segment originating on a side of the triangle and intersecting the opposite angle).

In the examples described, a temperature isolating layer permeable to the magnetic field generated by the induction coil 48, such as a thermal diode or heat reflector, can be arranged internal to the induction coil 48, between the induction coil 48 and the one or more susceptors 42. The temperature isolating layer inhibits heat flow from the one or more susceptors 42 to the induction coil 48. The closer the susceptor(s) 42 are positioned to the induction coil 48, the greater they are heated as the amount of energy transfer from the induction coil 48 to the susceptor(s) 42 is improved. However, the susceptor(s) 42 will also heat the induction coil 48 if placed too close together; increasing the coil temperature will decrease its efficiency. This presents a coil/susceptor paradox in that it is more efficient to heat the susceptor(s) 42 when they are closer to the induction coil 48, but the induction coil 48 is less efficient when the susceptors 42 are too close as it is itself heated. The temperature isolating layer addresses this issue by allowing the magnetic field generated by the induction coil 48 to pass from the induction coil 48 to the susceptor(s) 42 to heat the susceptor(s) 42 by induction, whilst inhibiting the transfer of heat from the susceptor(s) 42 back to the induction coil 48. This improves the efficiency of the induction coil 48, thereby improving the efficiency of the aerosol generation device 10. The temperature isolating layer also inhibits heat transfer through the aerosol generation device 10 by confining the generated heat to the heating chamber 18; this improves the efficiency of the heating of the aerosol generating article 102 and inhibits the device 10 undesirably heating in the user's hand.

In some examples the temperature isolating layer can be arranged within the sidewalls 30 of the heating chamber 18, between the induction coil 48 and the one or more susceptors 42. In other examples, the temperature isolating layer can be arranged on the inner surface 36 of the sidewalls 30 of the heating chamber 18, so as to be between the induction coil 48 and the one or more susceptors 42.

In the preceding examples, each helical strand of the induction coil 48 can be formed from one or more wires. For example, in FIG. 7 and FIG. 8, each of the helical strands 62, 64, 82, 84, 86 are formed from six adjacent wires, whereas in FIGS. 9A and 9B the helical strands 72, 74 are each formed from one wire. However, it is noted that each helical strand of the induction coils of FIGS. 7, 8, 9A and 9B can be formed from a single wire or a plurality of adjacent wires. The skilled person will understand that the numbers of wire per strand are purely exemplary and any suitable number of wires can be combined to form a strand in each of the examples.

The induction coil 48 of each of the preceding examples can comprise any number of loops or windings so as to induce the heating of the susceptors 42 to a suitable temperature. The induction coil 48 can partially or fully surround the susceptors 42 along their axial length in the heating chamber 18.

It will be readily understood that any of the features described with reference to FIGS. 7 to 11, such as the number of helical strands, the shape of the windings and the size of the windings, of the induction coil 48 can be combined where appropriate.

In order to use the aerosol generating device 10, a user displaces the sliding cover 28 (if present) from the closed position shown in FIG. 1 to the open position shown in FIG. 2. The user then inserts an aerosol generating article 100 through the open first end 26 into the heating chamber 18, so that the aerosol generating substrate 102 is received in the cavity 20 and so that the proximal end 104 of the aerosol generating article 100 is positioned at the open first end 26 of the heating chamber 18, with at least part of the mouthpiece segment 108 projecting from the open first end 36 to permit engagement by a user's lips.

Upon activation of the aerosol generating device 10 by a user, the induction coil 48 is energised by the power source 22 and controller 24 which supply an alternating electrical current to the induction coil 48, and an alternating and time-varying electromagnetic field is thereby produced by the induction coil 48. This couples with the inductively heatable susceptors 42 and generates eddy currents and/or magnetic hysteresis losses in the susceptors 42 causing them to heat up. The heat is then transferred from the inductively heatable susceptors 42 to the aerosol generating substrate 102, for example by conduction, radiation and convection. This results in heating of the aerosol generating substrate 102 without combustion or burning, and a vapour is thereby generated. The generated vapour cools and condenses to form an aerosol which can be inhaled by a user of the aerosol generating device 10 through the mouthpiece segment 108, and more particularly through the filter segment. The vaporisation of the aerosol generating substrate 102 is facilitated by the addition of air from the surrounding environment, for example through the open first end 26 of the heating chamber 18, the air being heated as it flows between the wrapper 110 of the aerosol generating article 100 and the inner surface 36 of the side wall 30. More particularly, when a user sucks on the filter segment, air is drawn into the heating chamber 18 through the open first end 26 as illustrated by the arrows A in FIG. 2. The air entering the heating chamber 18 flows from the open first end 26 towards the closed second end 34, between the wrapper 110 and the inner surface 36 of the side wall 30. As noted above, the inwardly extending portions 42a extend into the heating chamber 18 by a sufficient distance to at least contact the outer surface of the aerosol generating article 100, and typically to cause at least some degree of compression of the aerosol generating article 100. Consequently, there is no air gap all the way around the heating chamber 18 in the circumferential direction. Instead, there are air flow paths in the circumferential regions (four equally spaced gap regions) between the inwardly extending portions 42a along which air flows from the open first end 26 towards the closed second end 34 of the heating chamber 18. In some examples, there may be more or less than four inwardly extending portions 42a and, thus, a corresponding number of air flow paths formed by the gap regions between the inwardly extending portions 42a. When the air reaches the closed second end 34 of the heating chamber 18, it turns through approximately 180° and enters the distal end 106 of the aerosol generating article 100. The air is then drawn through the aerosol generating article 100 as illustrated by the arrow B in FIG. 2, from the distal end 106 towards the proximal (mouth) end 104 along with the generated vapour.

A user can continue to inhale aerosol all the time that the aerosol generating substrate 102 is able to continue to produce a vapour, e.g. all the time that the aerosol generating substrate 102 has vaporisable components left to vaporise into a suitable vapour. The controller 24 can adjust the magnitude of the alternating electrical current passed through the induction coil 48 to ensure that the temperature of the inductively heatable susceptors 42, and in turn the temperature of the aerosol generating substrate 102, does not exceed a threshold level. Specifically, at a particular temperature, which depends on the constitution of the aerosol generating substrate 102, the aerosol generating substrate 102 will begin to burn. This is not a desirable effect and temperatures above and at this temperature are avoided.

To assist with this, in some examples the aerosol generating device 10 is provided with a temperature sensor (not shown). In some examples, the temperature sensor can be a thermistor in direct contact with one or more of the susceptor(s) 42. The controller 24 is arranged to receive an indication of the temperature of the aerosol generating substrate 102 from the temperature sensor and to use the temperature indication to control the magnitude of the alternating electrical current supplied to the induction coil 48. In one example, the controller 24 may supply a first magnitude of electrical current to the induction coil 48 for a first time period to heat the inductively heatable susceptors 42 to a first temperature. Subsequently, the controller 24 may supply a second magnitude of alternating electrical current to the induction coil 48 for a second time period to heat the inductively heatable susceptors 42 to a second temperature. The second temperature may be lower than the first temperature. Subsequently, the controller 24 may supply a third magnitude of alternating electrical current to the induction coil 48 for a third time period to heat the inductively heatable susceptors 42 to the first temperature again. This may continue until the aerosol generating substrate 102 is expended (i.e. all vapour which can be generated by heating has already been generated) or the user stops using the aerosol generating device 10. In another scenario, once the first temperature has been reached, the controller 24 can reduces the magnitude of the alternating electrical current supplied to the induction coil 48 to maintain the aerosol generating substrate 102 at the first temperature throughout an aerosolisation session; in some examples, this can be considered a pre-heating phase followed by an aerosolisation phase.

A single inhalation by a user is generally referred to a “puff”. In some scenarios, it is desirable to emulate a cigarette smoking experience, which means that the aerosol generating device 10 is typically capable of holding sufficient aerosol generating substrate 102 to provide ten to fifteen puffs.

In some embodiments, the controller 24 is configured to count puffs and to interrupt the supply electrical current to the induction coil 48 after ten to fifteen puffs have been taken by a user. Puff counting can be performed in a variety of different ways. In some embodiments, the controller 24 determines when a temperature decreases during a puff, as fresh, cool air flows past the temperature sensor (not shown), causing cooling which is detected by the temperature sensor. In other embodiments, air flow is detected directly using a flow detector. Other suitable methods will be apparent to one of ordinary skill in the art. In other embodiments, the controller 24 additionally or alternatively interrupts the supply of electrical current to the induction coil 48 after a predetermined amount of time has elapsed since a first puff. This can help to both reduce power consumption and provide a back-up for switching off the aerosol generating device 10 in the event that the puff counter fails to correctly register that a predetermined number of puffs has been taken.

In some examples, the controller 24 is configured to supply an alternating electrical current the induction coil 48 so that it follows a predetermined heating cycle, which takes a predetermined amount of time to complete. Once the cycle is complete, the controller 24 interrupts the supply of electrical current to the induction coil 48. In some cases, this cycle may make use of a feedback loop between the controller 24 and a temperature sensor (not shown). For example, the heating cycle may be parameterised by a series of temperatures to which the inductively heatable susceptors 42 (or, more specifically the temperature sensor) are heated or allowed to cool. The temperatures and durations of such a heating cycle can be empirically determined to optimise the temperature of the aerosol generating substrate 102. This may be necessary as direct measurement of the temperature of the aerosol generating substrate 102 can be impractical, or misleading, for example where the outer layer of substrate is a different temperature to the core.

The power source 22 is sufficient to at least bring the aerosol generating substrate 102 in a single aerosol generating article 100 up to the first temperature and maintain it at the first temperature to provide sufficient vapour for at least ten to fifteen puffs. More generally, in line with emulating the experience of cigarette smoking, the power source 22 is usually sufficient to repeat this cycle (bring the aerosol generating substrate 102 up to the first temperature, maintain the first temperature and vapour generation for ten to fifteen puffs) ten times, or even twenty times, thereby emulating a user's experience of smoking a packet of cigarettes, before there is a need to replace or recharge the power source 22.

In general, the efficiency of the aerosol generating device 10 is improved when as much as possible of the heat that is generated by the inductively heatable susceptors 42 results in heating of the aerosol generating substrate 102. To this end, the aerosol generating device 10 is usually configured to provide heat in a controlled manner to the aerosol generating substrate 102 while reducing heat flow to other parts of the aerosol generating device 10. In particular, heat flow to parts of the aerosol generating device 10 that the user handles is kept to a minimum, thereby keeping these parts cool and comfortable to hold.

It will be understood that features described with reference to the preceding examples can be combined with one another as appropriate.

1. An aerosol generation device heating component, the heating component comprising an electromagnetic field generator configured to at least partially surround a heating chamber, the heating chamber configured to house one or more susceptors heatable by the electromagnetic field generator, and the electromagnetic field generator comprising a plurality of co-wound helical strands, wherein:
each helical strand of the plurality of co-wound helical strands is coiled to comprise a plurality of windings; and
the windings of a first helical strand of the plurality of co-wound helical strands are of a first size, and the windings of a second helical strand of the plurality of co-wound helical strands are of a second size, wherein the first size and the second size are different sizes.

2. The aerosol generation device heating component of claim 1, wherein the plurality of co-wound helical strands are interleaved such that the windings of the first helical strand alternate with the windings of the second helical strand at least partially along an axial length of the electromagnetic field generator.

3. The aerosol generation device heating component of claim 2, wherein the plurality of co-wound helical strands further comprises a third helical strand and the plurality of co-wound helical strands are interleaved such that the windings of the first, second and third helical strands alternate with one another at least partially along the axial length of the electromagnetic field generator, and wherein the windings of the third helical strand are the same size as the windings of one of the first helical stand and the second helical strand.

4. The aerosol generation device heating component of claim 1, wherein the windings of the first helical strand have a diameter less than a diameter of the windings of the second helical strand.

5. The aerosol generation device heating component of claim 1, wherein the plurality of windings are substantially circular.

6. The aerosol generation device heating component of claim 1, wherein the plurality of windings are substantially triangular.

7. The aerosol generation device heating component of claim 1, wherein the electromagnetic field generator is an induction coil configured to heat the one or more susceptors arranged within the heating chamber.

8. The aerosol generation device heating component of claim 7, further comprising a temperature isolating layer internal to the induction coil and configured to be between the induction coil and the one or more susceptors, wherein the temperature isolating layer is permeable to a magnetic field generated by the induction coil and is arranged to inhibit heat flow from the one or more susceptors to the induction coil.

9. The aerosol generation device heating component of claim 8, wherein the temperature isolating layer is at least one of a thermal diode or a heat reflector.

10. The aerosol generation device heating component of claim 1, wherein the windings of the first helical strand are configured to be closer to the one or more susceptors than the windings of the second helical strand.

11. The aerosol generation device heating component of claim 1, wherein each helical strand of the plurality of co-wound helical strands is separately connectable to a controller configured to selectively power each of the helical strands of the plurality of co-wound helical strands.

12. The aerosol generation device heating component of claim 1, wherein each helical strand of the plurality of co-wound helical strands is formed from one or more wires configured to generate an electromagnetic field when an AC current is passed through the one or more wires.

13. The aerosol generation device heating component of claim 1, wherein each helical strand of the plurality of co-wound helical strands is formed from a plurality of adjacent wires.

14. An aerosol generation device comprising the heating component of claim 1 and a heating chamber configured to receive an aerosol generating article.

15. The aerosol generation device of claim 14, further comprising one or more susceptors arranged in the heating chamber.

16. The aerosol generation device of claim 15, wherein the electromagnetic field generator is configured to inductively heat the one or more susceptors to heat without burning an aerosol generating article received in the heating chamber.

17. The aerosol generation device heating component of claim 2, wherein the plurality of co-wound helical strands further comprises a third helical strand and the plurality of co-wound helical strands are interleaved such that the windings of the first, second and third helical strands alternate with one another at least partially along the axial length of the electromagnetic field generator, and wherein the windings of the third helical strand are a different size to the windings of both the first helical strand and the second helical strand.
